(19) United States
(12) Patent Application Publication
(10) Pub. No.: US 2026/0254911 A1
(43) Pub. Date: Aug. 27, 2026

(54) DEVICE AND METHOD FOR SUPPORTING DETERMINATION OF MAXIMUM INK AMOUNT

(71) Applicant: SEIKO EPSON CORPORATION, Tokyo (JP)

(72) Inventor: Yoshio OKUMURA, MATSUMOTO-SHI (JP)

(21) Appl. No.: 19/429,350

(22) Filed: Dec. 22, 2025

(30) Foreign Application Priority Data
Dec. 24, 2024 (JP) 2024-227528

(51) Int. Cl. H04N 1/23; H04N 1/60

(52) U.S. Cl. CPC H04N 1/2346; H04N 1/2392; H04N 1/605; H04N 2201/0082

(57) ABSTRACT

A processing unit of a support device performs division processing of dividing each of test images into a predetermined number to acquire a plurality of divided test images; predicted value acquisition processing of executing a trained model using each of the divided test images as an input to acquire a predicted value indicating a probability that an ink amount per unit area of each of the divided test images is appropriate as a maximum ink amount; and output processing of outputting, based on the ink amount per unit area corresponding to each of the test images and the plurality of predicted values, prediction information indicating whether the ink amount per unit area of each of the test images is within an appropriate range of the maximum ink amount or out of the appropriate range.

The present application is based on, and claims priority from JP Application Serial Number 2024-227528, filed December 24, 2024, the disclosure of which is hereby incorporated by reference herein in its entirety.

### BACKGROUND

### 1. Technical Field

The present disclosure relates to a device and a method for supporting determination of a maximum ink amount that is an upper limit of an ink amount per unit area in a printing medium.

### 2. Related Art

As a printing device, an inkjet printer that dispenses ink droplets from a printing head to a printing medium is known. When a dispensing amount of an ink per unit area with respect to the printing medium is large, for example, a bleeding phenomenon in which the ink bleeds out to a periphery occurs, and a color saturation state in which color development hardly changes even when the ink dispensing amount increases is obtained. Therefore, a maximum ink amount that is an upper limit of the ink amount per unit area on the printing medium is set and used for creating a color conversion LUT (lookup table) or the like.

JP-A-2021-24152 discloses an information processing device that estimates an optimum maximum ink amount using a trained model generated by machine learning. The estimated maximum ink amount is one of optimum values, and the optimum value is used to generate the color conversion LUT.

JP-A-2021-24152 is an example of the related art.

However, even when the user cannot satisfy the maximum ink amount that is the inference result by the trained model, the color conversion LUT is generated according to the inference result. Therefore, a new mechanism for the user to determine the maximum ink amount is desired.

### SUMMARY

A support device according to the present disclosure is a support device for supporting determination of a maximum ink amount, that is an upper limit of an ink amount per unit area on a printing medium, which includes:

a holding unit configured to hold a plurality of test images respectively obtained by reading a plurality of test patches having different ink amounts per unit area on the printing medium; and

a processing unit configured to execute a trained model that causes a computer to function to acquire, based on a plurality of divided test images obtained by dividing each of the test images into a predetermined number, a predicted value indicating a probability that the ink amount per unit area of each of the divided test images is appropriate as the maximum ink amount,

### The Processing unit Performs

division processing of dividing each of the test images into the predetermined number to acquire the plurality of divided test images,

predicted value acquisition processing of executing the trained model using each of the divided test images as an input to acquire the predicted value, and

output processing of outputting, based on the ink amount per unit area corresponding to each of the test images and the plurality of predicted values, prediction information indicating whether the ink amount per unit area of each of the test images is within an appropriate range of the maximum ink amount or out of the appropriate range.

In addition, a support method of the present disclosure is a support method for causing a computer to perform processing of supporting determination of a maximum ink amount that is an upper limit of an ink amount per unit area on a printing medium,

the computer being configured to execute a trained model that causes the computer to function to acquire, based on a plurality of divided test images obtained by dividing each of a plurality of test images obtained by reading a plurality of test patches having different ink amounts per unit area on the printing medium, into a predetermined number, a predicted value indicating a probability that the ink amount per unit area of each of the divided test images is appropriate as the maximum ink amount,

### The Support Method Includes:

a division step of dividing each of the test images into the predetermined number to acquire the plurality of divided test images;

a predicted value acquisition step of executing the trained model using each of the divided test images as an input to acquire the predicted value; and

an output step of outputting, based on the ink amount per unit area corresponding to each of the test images and the plurality of predicted values, prediction information indicating whether the ink amount per unit area of each of the test images is within an appropriate range of the maximum ink amount or out of the appropriate range.

In addition, a trained model generation device of the present disclosure is a trained model generation device for supporting determination of a maximum ink amount that is an upper limit of an ink amount per unit area on a printing medium, the trained model generation device including:

a holding unit configured to hold a plurality of training images respectively obtained by reading a plurality of trained patches having different ink amounts per unit area; and

a processing unit configured to generate a trained model that causes a computer to function to acquire, based on a plurality of divided test images obtained by dividing each of the plurality of test images obtained by reading a plurality of test patches having different ink amounts per unit area in the printing medium into the predetermined number, a predicted value indicating a probability that the ink amount per unit area of each of the divided test images is appropriate as the maximum ink amount, by machine learning based on a relationship between a label indicating whether the ink amount per unit area of each of the trained patches is appropriate as the maximum ink amount, exceeds an appropriate amount, or falls below the appropriate amount, and a plurality of divided training images obtained by dividing each of the training images into the predetermined number.

### BRIEF DESCRIPTION OF THE DRAWINGS

FIG. 1 is a block diagram schematically showing a configuration example of a support system including a trained model generation device and a support device.

FIG. 2 is a diagram schematically showing an example of a chart on a printing medium.

FIG. 3 is a diagram schematically showing an example of a training chart image and a test chart image.

FIG. 4 is a diagram schematically showing an example of generating a data set from a plurality of training images having different ink amounts per unit area.

FIG. 5 is a diagram schematically showing an example of a trained model generated by the trained model generation device and used by the support device.

FIG. 6 is a diagram schematically showing an example of prediction information indicating whether the ink amount per unit area of each test image is within an appropriate range of a maximum ink amount or out of the appropriate range.

FIG. 7 is a diagram schematically showing a display example of an assist screen including prediction information.

FIG. 8 is a flowchart schematically showing an example of trained model generation processing.

FIG. 9 is a flowchart schematically showing an example of support processing.

FIG. 10 is a flowchart schematically showing an example of classification processing.

FIG. 11 is a diagram schematically showing an example of a structure of a color conversion lookup table.

### DESCRIPTION OF EMBODIMENTS

An embodiment of the present disclosure will be described below. The following embodiment, of course, merely shows an example of the present disclosure, and all the features shown in the embodiment are not necessarily essential to the solution disclosed herein.

### 1. Overview of Aspects Included in Present Disclosure:

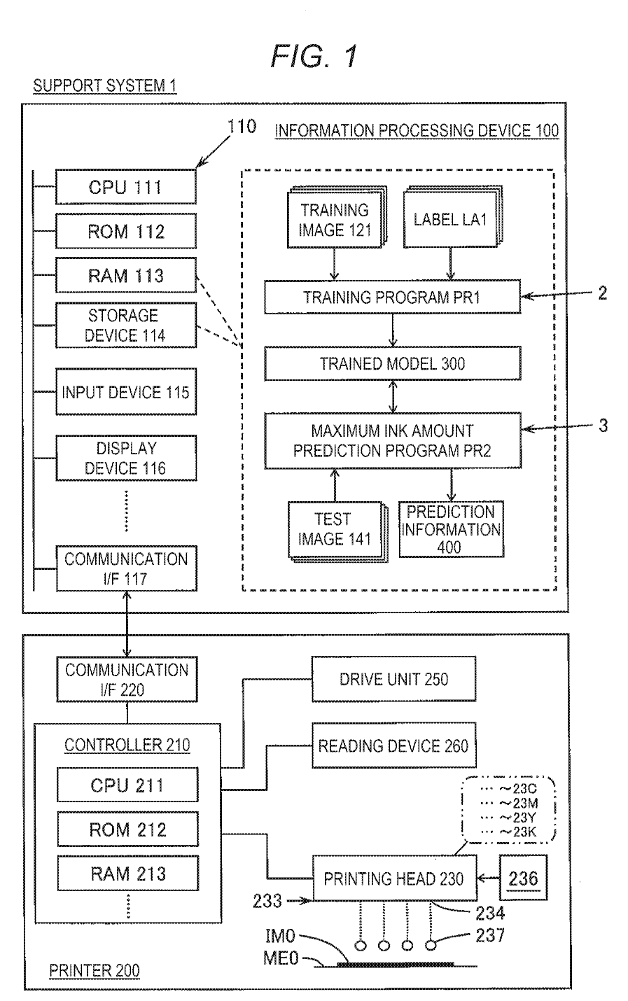

An overview of aspects included in the present disclosure will first be described with reference to examples shown in FIGS. 1 to 11. The drawings in the present application schematically show examples, and that the magnification in each direction shown in the drawings may vary and the drawings may not be consistent with each other. Obviously, each element in the present aspects is not limited to a specific example denoted by the reference symbol. In "Overview of aspects included in present disclosure", a term in parentheses means a supplementary description of the term immediately before the parentheses.

In the present application, a numerical range "Min to Max" means numerals equal to or greater than a minimum value Min but equal to or smaller than a maximum value Max.

### Aspect 1

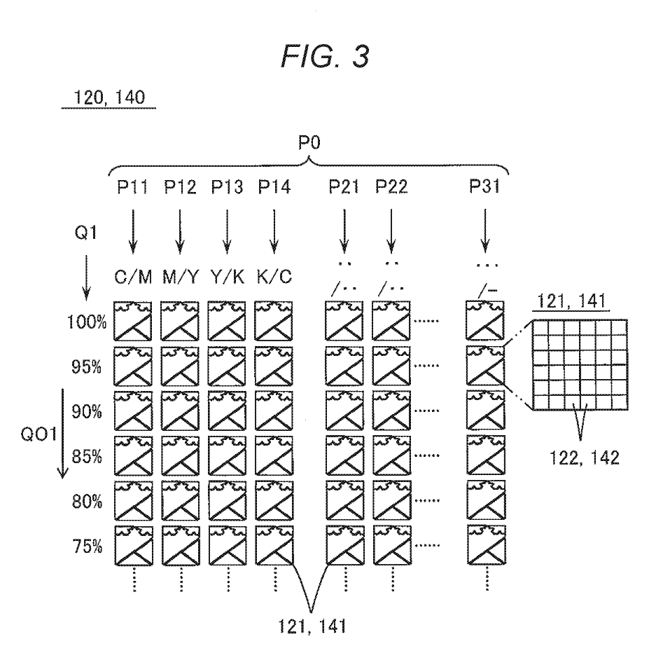

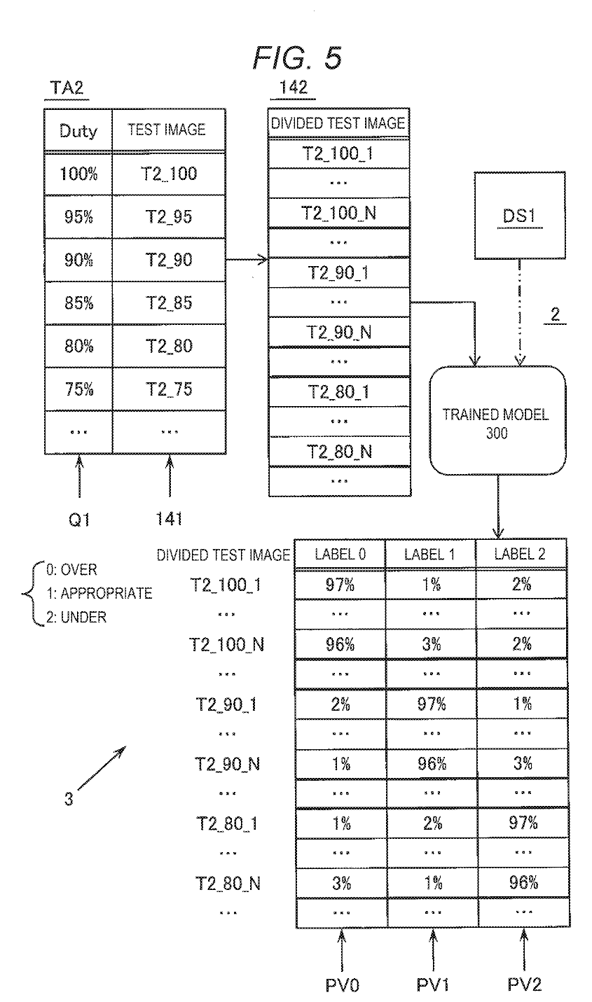

As shown in FIG. 1, a support device 3 according to an aspect is a support device 3 for supporting determination of a maximum ink amount Qm that is an upper limit of an ink amount Q1 per unit area in a printing medium ME0, and includes a holding unit (for example, a RAM 113) and a processing unit 110. The holding unit (113) holds a plurality of test images 141 obtained by reading a plurality of test patches PA2 having different ink amounts Q1 per unit area on the printing medium ME0. As shown in FIG. 5, the processing unit 110 can execute a trained model 300 that causes a computer (for example, an information processing device 100) to function so as to acquire a predicted value (for example, a predicted value PV1) indicating a probability that the ink amount Q1 per unit area of each of the divided test images 142 is appropriate as the maximum ink amount Qm based on a plurality of divided test images 142 obtained by dividing each of the test images 141 into a predetermined number (for example, N). The processing unit 110 performs the following processing as shown in FIGS. 3, 6, 7, 9, and 10 .

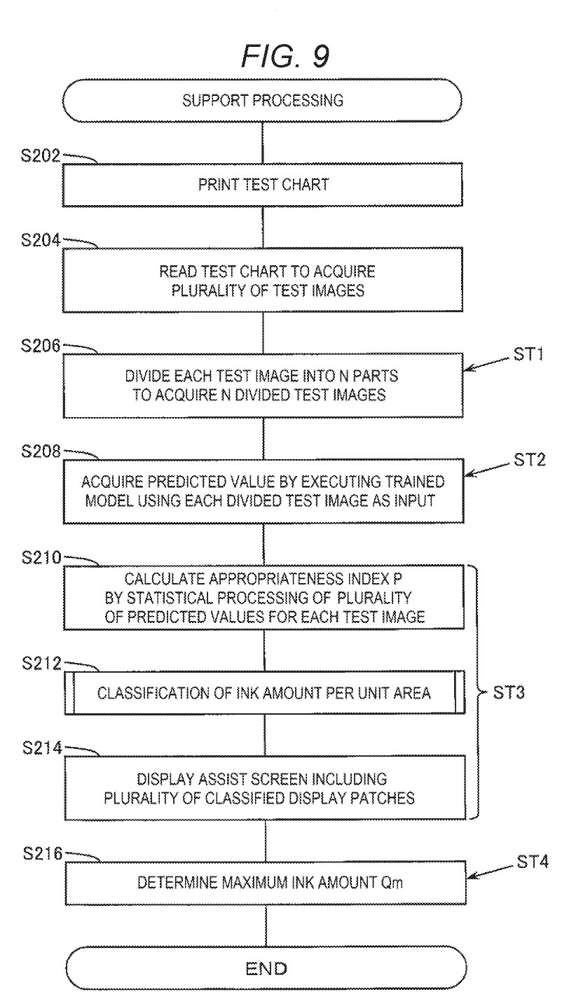

(a1) Division processing of acquiring a plurality of divided test images 142 by dividing each of the test images 141 into a predetermined number (N) (for example, step S206 in FIG. 9).

(a2) Predicted value acquisition processing of acquiring the predicted value (PV1) by executing the trained model 300 using each of the divided test images 142 as an input (for example, step S208 in FIG. 9).

(a3) Output processing of outputting prediction information 400 indicating whether the ink amount Q1 per unit area of each of the test images 141 is within an appropriate range of the maximum ink amount Qm or out of the appropriate range based on the ink amount Q1 per unit area corresponding to each of the test images 141 and the plurality of predicted values (PV1) (for example, steps S210 to S214 in FIG. 9).

When the trained model 300 is executed by inputting the plurality of divided test images 142 obtained by dividing each of the plurality of test images 141 obtained by reading the plurality of test patches PA2 having different ink amounts Q1 per unit area, a plurality of predicted values (PV1) indicating a probability that the ink amount Q1 per unit area of each of the divided test images 142 is appropriate as the maximum ink amount Qm are acquired. Accordingly, information indicating that the ink amount Q1 per unit area is predicted to be appropriate or inappropriate as the maximum ink amount Qm is finely obtained for each of the test patches PA2. The output prediction information 400 is based on the ink amount Q1 per unit area and the plurality of predicted values (PV1) corresponding to each of the test images 141. The prediction information 400 is not limited to one recommended value, and indicates whether the ink amount Q1 per unit area of each test image 141 is in the appropriate range of the maximum ink amount Qm or out of the appropriate range. Accordingly, a user can reflect his/her desire in the determination of the maximum ink amount Qm while referring to the appropriate range predicted with a width. Therefore, in the above aspect, it is possible to provide a support device capable of determining the maximum ink amount in consideration of the desire of the user.

Various examples are listed in the aspect described above.

The ink is generally a liquid containing a colorant such as a pigment or a dye, and may be a powdery solid such as a toner ink.

The plurality of test patches may be read by a scanner or may be read by a camera or the like. Therefore, the plurality of test images may be images read by a scanner, images captured by a camera, or the like.

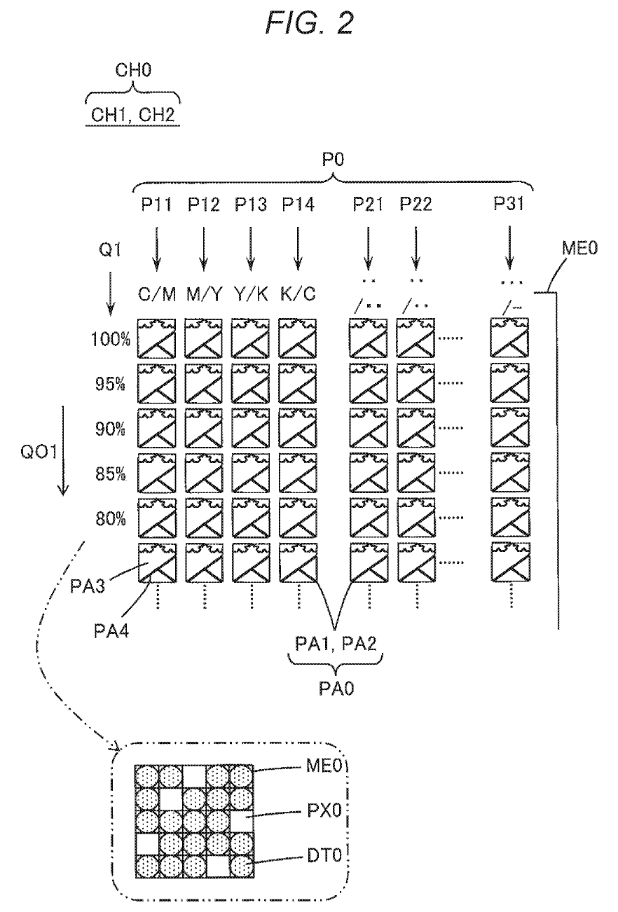

The patch including the test patch and a trained patch to be described later may include a pattern such as a linear image, or may be a solid patch having a uniform recording density. To describe with reference to FIGS. 1 and 2, the recording density (referred to as RD) means a ratio (including a percentage) of the number of dots DT0 formed by ink droplets 237 with respect to a predetermined number of pixels PX0 on the printing medium ME0, and means a ratio when converted to a largest dot (for example, a large dot) when dots having different sizes are formed. A pixel PX0 is a minimum element constituting an image and can be assigned a color independently. Although 25 pixels PX0 are shown in FIG. 2, when Nd large dots are formed with respect to 100 pixels PX0, the recording density RD is Nd%. The ink amount Q1 per unit area means the amount of ink dispensed from the printing head 230 to a unit area of the printing medium ME0, corresponds to the ink amount for forming a patch PA0 of the recording density RD on the printing medium ME0, and is substantially equal to the recording density RD.

The ink amount per unit area of each test image is out of the appropriate range of the maximum ink amount includes whether the ink amount per unit area of each test image exceeds or falls below the appropriate range. Therefore, the prediction information may indicate whether the ink amount per unit area of each test image is in the appropriate range of the maximum ink amount, exceeds the appropriate range, or falls below the appropriate range.

The output of the prediction information may be display of the prediction information, printing of the prediction information, audio output, or the like.

Obviously, the additional remarks described above also apply to the following configurations.

### Aspect 2

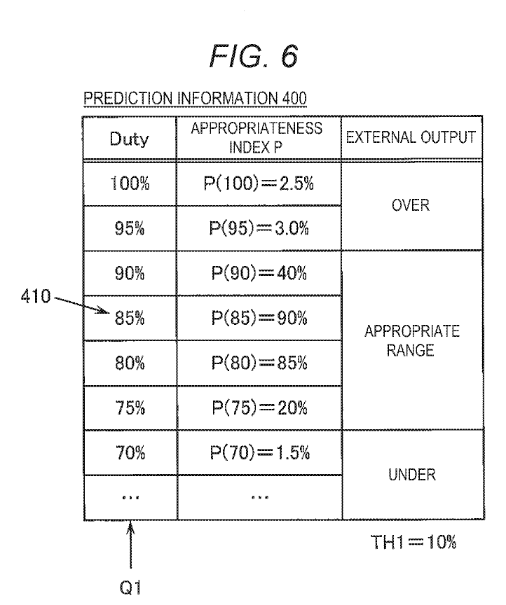

As shown in FIGS. 6, 7, 9, and 10, in the output processing, the processing unit 110 may calculate an appropriateness index P indicating a probability that the ink amount Q1 per unit area corresponding to the test image 141 is appropriate by performing statistical processing on the plurality of predicted values (PV1) obtained by executing the trained model 300 for each of the test images 141. In the output processing, the processing unit 110 may generate the prediction information 400 based on the appropriateness index P for each ink amount Q1 per unit area, or may output the prediction information 400.

In this case, it is possible to provide a preferable example of generating the prediction information.

Here, the statistical processing may be average processing of calculating an arithmetic mean of the plurality of predicted values (PV1), processing of extracting a median value when the plurality of predicted values (PV1) are arranged in order (ascending order or descending order), or the like. The additional remark described above also applies to the following aspects.

### Aspect 3

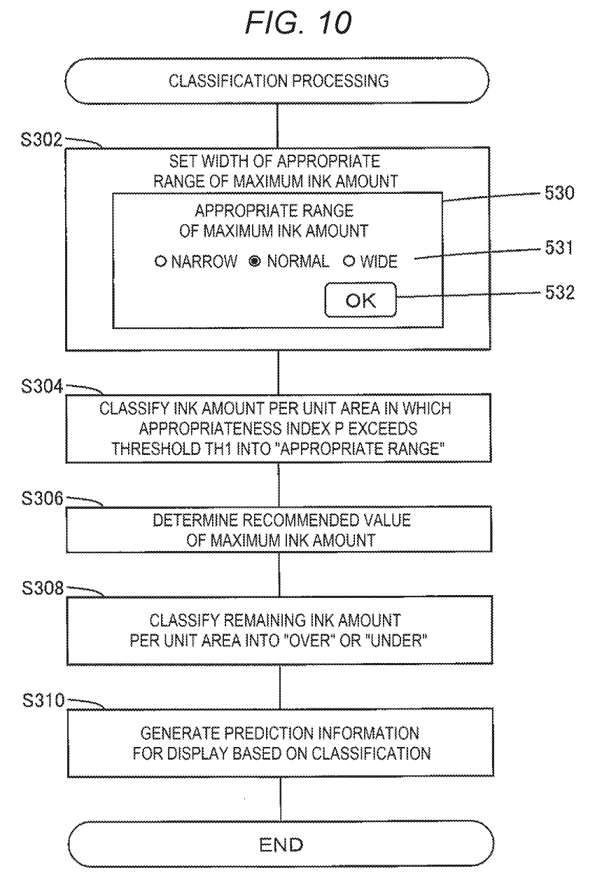

As shown in FIGS. 6 and 10, in the output processing, the processing unit 110 may compare the calculated appropriateness index P with a threshold TH1, and determine that the ink amount Q1 per unit area in which the appropriateness index P exceeds the threshold TH1 is within the appropriate range. The support device 3 may further include an operation unit (for example, an input device 115) for receiving an operation of changing the threshold TH1.

In this case, the user can perform an operation of changing a correction range according to his/her desire. Therefore, the above aspect can improve the convenience of determining the maximum ink amount.

### Aspect 4

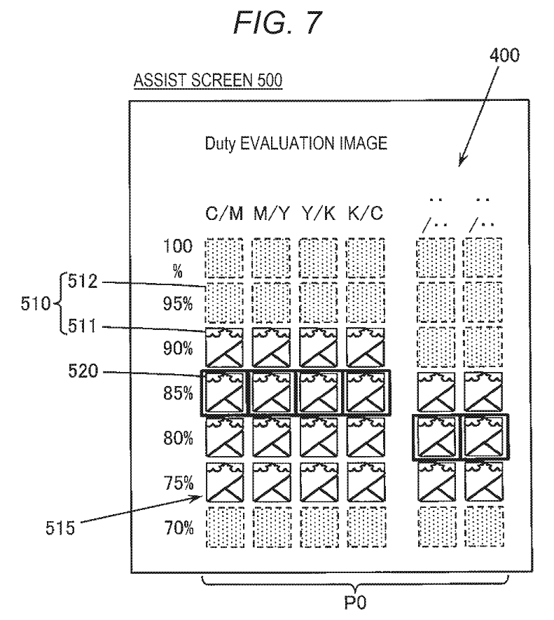

As shown in FIG. 7, the processing unit 110 may display a plurality of display patches 510 respectively corresponding to the plurality of test patches PA2 on a display unit (for example, a display device 116). The plurality of display patches 510 may include a plurality of appropriate range patches 511 in which the corresponding ink amount Q1 per unit area is in the appropriate range, and a plurality of inappropriate range patches 512 that are not the appropriate range patches 511. In the output processing, the processing unit 110 may cause the display unit (116) to display the plurality of display patches 510 including display information 515 for distinguishing the plurality of appropriate range patches 511 from the plurality of inappropriate range patches 512 as the prediction information 400.

In the above case, since the user can visually recognize the plurality of appropriate range patches 511 in the plurality of display patches 510 respectively corresponding to the plurality of test patches PA2, the user can easily check the test patch PA2 in the appropriate range among the plurality of test patches PA2. Therefore, the above aspect can improve the convenience of determining the maximum ink amount.

### Aspect 5

As shown in FIGS. 1 and 7, the support device 3 may further include the operation unit (115) for receiving an operation on the plurality of display patches 510 displayed on the display unit (116). As shown in FIG. 9, the processing unit 110 may further perform the following processing.

(a4) When the operation unit (115) receives an operation on any one of the plurality of display patches 510, maximum ink amount setting processing of setting the ink amount Q1 per unit area corresponding to the operated display patch 510 to the maximum ink amount Qm (for example, step S216 in FIG. 9).

In this case, since the maximum ink amount Qm can be set by operating the display patch 510, the convenience of determining the maximum ink amount can be further improved.

### Aspect 6

Instead, the processing unit 110 may further perform the following processing.

(a5) Maximum ink amount setting processing of setting the ink amount Q1 per unit area corresponding to the operated appropriate range patch 511 to the maximum ink amount Qm when the operation unit (115) prohibits the operation on the plurality of inappropriate range patches 512 and when the operation unit (115) receives an operation on any of the plurality of appropriate range patches 511.

In this case, since the ink amount Q1 per unit area determined as the maximum ink amount Qm is in the appropriate range, it is possible to further improve the convenience of determining the maximum ink amount.

### Aspect 7

As shown in FIGS. 6 and 10, in the output processing, the processing unit 110 may determine the recommended value 410 of the maximum ink amount Qm based on the ink amount Q1 per unit area corresponding to each of the test images 141 and the plurality of predicted values (PV1). As shown in FIG. 7, in the output processing, the processing unit 110 may output the recommendation information (for example, a recommended patch 520) indicating the recommended value 410 in addition to the prediction information 400.

In the above case, since the recommendation information (520) indicating the recommended value 410 of the maximum ink amount Qm is also output, the user can select the recommended value 410 according to the recommendation information (520). Therefore, the above aspect can improve the convenience of determining the maximum ink amount.

### Aspect 8

A support method according to an aspect is a support method in which the computer (100) performs processing of supporting the determination of the maximum ink amount Qm which is the upper limit of the ink amount Q1 per unit area in the printing medium ME0. The computer (100) can execute the trained model 300. As shown in FIGS. 3, 6, 7, 9, and 10, the present support method includes the following steps.

(b1) A division step ST1 of acquiring a plurality of divided test images 142 by dividing each of the test images 141 into the predetermined number (N).

(b2) A predicted value acquisition step ST2 of acquiring the predicted value (PV1) by executing the trained model 300 using each of the divided test images 142 of as an input.

(b3) An output step ST3 of outputting prediction information 400 indicating whether the ink amount Q1 per unit area of each of the test images 141 is within an appropriate range of the maximum ink amount Qm or out of the appropriate range based on the ink amount Q1 per unit area corresponding to each of the test images 141 and the plurality of predicted values (PV1).

In the above aspect, it is possible to provide a support method capable of determining the maximum ink amount in consideration of the desire of the user.

### Aspect 9

As shown in FIG. 1, a trained model generation device 2 according to an aspect is a trained model generation device 2 for supporting determination of the maximum ink amount Qm that is an upper limit of the ink amount Q1 per unit area in a printing medium ME0, and includes the holding unit (113) and the processing unit 110. The holding unit (113) holds a plurality of training images 121 obtained by reading a plurality of trained patches PA1 having different ink amounts Q1 per unit area. As shown in FIGS. 3 to 5, and 8, the processing unit 110 generates the trained model 300 that causes the computer (100) to function to acquire, based on a plurality of divided test images 142 obtained by dividing each of the plurality of test images 141 obtained by reading the plurality of test patches PA2 having different ink amounts Q1 per unit area in the printing medium ME0 into the predetermined number (N), the predicted value (PV1) indicating the probability that the ink amount Q1 per unit area of each of the divided test images 142 is appropriate as the maximum ink amount Qm by machine learning based on the relationship between a label LA1 indicating whether the ink amount Q1 per unit area of each of the trained patches PA1 is appropriate as the maximum ink amount Qm, exceeds the appropriate ink amount Qm, or falls below the appropriate ink amount Qm, and the plurality of divided training images 122 obtained by dividing each of the training images 121 into the predetermined number (N).

When the trained model 300 is executed by inputting the plurality of divided test images 142 obtained by dividing each of the plurality of test images 141 obtained by reading the plurality of test patches PA2 having different ink amounts Q1 per unit area, a plurality of predicted values (PV1) indicating a probability that the ink amount Q1 per unit area of each of the divided test images 142 is appropriate as the maximum ink amount Qm are acquired. Accordingly, information indicating that the ink amount Q1 per unit area is predicted to be appropriate or inappropriate as the maximum ink amount Qm is finely obtained for each of the test patches PA2. The user can reflect his/her desire in the determination of the maximum ink amount Qm while referring to the obtained prediction information 400. Therefore, in the above aspect, it is possible to provide a trained model generation device capable of acquiring prediction information that is used as a reference when the user determines the maximum ink amount in consideration of the desire of the user.

Here, the plurality of trained patches PA1 may be read by a scanner or may be read by a camera or the like. Therefore, the plurality of training images 121 may be images read by a scanner, images captured by a camera, or the like.

Further, the above-described aspect is applicable to a support system including the above-described trained model generation device and the above-described support device, a trained model generation method for generating the above-described trained model, a trained model generation program of generating the above-described trained model, a control program of the above-described support device, a computer-readable non-transitory medium in which any of the above-described programs is recorded, the above-described trained model, a computer-readable non-transitory medium in which the trained model is recorded, and the like. Any of the devices described above may include a plurality of dispersed portions.

### 2. Configuration Example of Trained Model Generation Device and Support Device:

FIG. 1 schematically shows a configuration of a support system 1 including the trained model generation device 2 and the support device 3. FIG. 2 schematically shows a chart CH0 on the printing medium ME0. FIG. 2 collectively shows a trained chart CH1 and a test chart CH2 as the chart CH0. In FIG. 2, a schematic diagram showing an example of the ink amount Q1 per unit area is shown in a region surrounded by a two-dot chain line.

The support system 1 shown in FIG. 1 includes the information processing device 100 that can be the trained model generation device 2 and the support device 3, and a printer 200 capable of forming a print image IM0 including a chart CH0.

The information processing device 100 includes a central processing unit (CPU) 111, a read only memory (ROM) 112, a random access memory (RAM) 113, a storage device 114, an input device 115, a display device 116, a communication interface (I/F) 117, and the like. The elements (111 to 117) described above are electrically coupled to each other and can input and output information to and from each other. The ROM 112, the RAM 113, and the storage device 114 are memories, and at least the ROM 112 and the RAM 113 are semiconductor memories. The information processing device 100 includes the processing unit 110 mainly formed of the CPU 111. The RAM 113 is an example of a holding unit. The input device 115 is an example of an operation unit. The display device 116 is an example of a display unit.

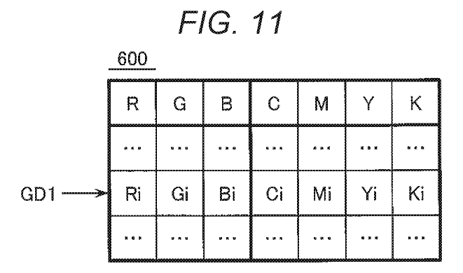

The storage device 114 stores an operating system (OS) (not shown), a training program PR1, a maximum ink amount prediction program PR2, a color conversion LUT (lookup table) 600 shown in FIG. 11, and the like. The training program PR1 causes the information processing device 100, which is a computer, to function as the trained model generation device 2. In order to execute the training program PR1, a plurality of training images 121 included in the trained chart CH1 shown in FIG. 2 and a plurality of labels LA1 respectively associated with the plurality of training images 121 are stored in the RAM 113. After the training program PR1 is executed, the trained model 300 is stored in the storage device 114. The maximum ink amount prediction program PR2 causes the information processing device 100 to function as the support device 3. In order to execute the maximum ink amount prediction program PR2, a plurality of test images 141 included in the test chart CH2 shown in FIG. 2 are stored in the RAM 113. After the maximum ink amount prediction program PR2 is executed, the prediction information 400 is stored in the RAM 113. In the color conversion LUT 600 shown in FIG. 11, a correspondence relationship between coordinate values of R (red), G (green), and B (blue) and coordinate values of C (cyan), M (magenta), Y (yellow), and K (black) is defined for a plurality of grid points GD1. A variable i shown in FIG. 11 is a variable for identifying each of the grid points GD1. Since both the RAM 113 and the storage device 114 are memories, the storage device 114 may function as an information holding unit, or the RAM 113 may hold the trained model 300.

Examples of the storage device 114 may include a nonvolatile semiconductor memory such as a flash memory, and a magnetic storage device such as a hard disk.

Examples of the input device 115 include a pointing device, hardware keys such as a keyboard, and a touch panel attached to a surface of a display panel. The input device 115 may be an external device coupled to the main body of the information processing device 100. Examples of the display device 116 include a liquid crystal display and an organic EL display. The display device 116 may be an external device coupled to the main body of the information processing device 100. The communication I/F 117 is coupled to the communication I/F 220 of the printer 200 and inputs and outputs information such as print data to and from the printer 200.

The CPU 111 reads information stored in the storage device 114 as appropriate into the RAM 113 and executes the read programs to perform various kinds of processing. The CPU 111 executes the training program PR1 read by the RAM 113 to perform processing corresponding to the function of the trained model generation device 2. In addition, the CPU 111 performs the processing corresponding to the function of the support device 3 by executing the maximum ink amount prediction program PR2 read in the RAM 113. Further, the CPU 111 executes a print control program (not shown) to perform color conversion processing, halftone processing, print data generation processing, and the like. For example, as the color conversion processing, the CPU 111 performs processing of converting RGB data having an integer value equal to or greater than 2⁸ gradations of R, G, and B in each pixel into ink amount data according to the color conversion LUT 600 of FIG. 11. The ink amount data has, for example, an integer value equal to or greater than 2⁸ gradations of C, M, Y, and K in each pixel. The CPU 111 performs, as the halftone processing, processing of generating dot data in which the number of gradations is reduced by performing the halftone processing on the ink amount data. The CPU 111 performs processing of generating the print data by adding command data to the dot data as print data generation processing. The computer-readable non-transitory recording medium storing the programs (PR1, PR2, and the like) is not limited to the storage device inside the information processing device 100, and may be a recording medium outside the information processing device 100.

The number of the CPUs 111 of the processing unit 110 may be one or two or more. In addition, a part or all of the processing unit 110 can be replaced with hardware such as a digital signal processor (DSP), an application specific integrated circuit (ASIC), a programmable logic device (PLD), and a field programmable gate array (FPGA).

The information processing device 100 may include at least a part of the printer 200. The information processing device 100 may include all the components (111 to 117) in one housing, or may include a plurality of devices that are divided so as to be able to communicate with each other. Therefore, the information processing device 100 may be one personal computer, a combination of a mobile phone such as a smartphone and one or more personal computers, a combination of one or more server computers and one or more terminals, or the like. The trained model generation device 2 and the support device 3 may be implemented by separate computers.

The printer 200 shown in FIG. 1 is an inkjet printer that ejects a C (cyan) ink, a M (magenta) ink, a Y (yellow) ink, and a K (black) ink as an ink 236 containing a color material from the printing head 230 onto the printing medium ME0. Therefore, the ink 236 shown in FIG. 1 has four types of different colors. The printer 200 includes a controller 210, the above-described communication I/F 220, a printing head 230, a drive unit 250, a reading device 260, and the like. The reading device 260 can read the chart CH0 on the printing medium ME0. Examples of the reading device 260 include a scanner and an imaging device. The reading device 260 may be a main body of the printer 200 or an external device coupled to the information processing device 100.

The controller 210 includes a CPU 211, a ROM 212, a RAM 213, a drive signal transmission unit, and the like, and controls operations of the communication I/F 220, the printing head 230, the drive unit 250, the reading device 260, and the like. The controller 210 controls the dispensing of the ink droplets 237 by the printing head 230 according to the dot data included in the print data acquired from the information processing device 100. The controller 210 may control a relative movement between the printing medium ME0 and the printing head 230 by the drive unit 250. In this way, the print image IM0 corresponding to the print data is formed at the printing medium ME0. The controller 210 can also execute control to transmit an image read by the reading device 260 from the communication I/F 220 to the information processing device 100. The controller 210 can be formed of a system on a chip (SoC) or the like.

The printing head 230 includes a drive circuit, a drive element, and the like, and performs printing by dispensing the ink droplets 237 onto the printing medium ME0 from a plurality of nozzles 234 included in a nozzle row 233. Here, the nozzle means a small opening through which ink droplets are dispensed, and the nozzle row means an arrangement of the plurality of nozzles. The printing head 230 shown in FIG. 1 includes a C nozzle row 23C that dispenses C ink droplets 237, an M nozzle row 23M that dispenses M ink droplets 237, a Y nozzle row 23Y that dispenses Y ink droplets 237, and a K nozzle row 23K that dispenses K ink droplets 237. The drive elements can, for example, each be a piezoelectric element that applies a pressure to an ink in a pressure chamber that communicates with the nozzles 234, or a drive element that dispenses the ink droplets 237, from the nozzles 234 by generating bubbles in the pressure chamber with the aid of heat. For example, when binary dot data based on the print data is "dot formation", the controller 210 outputs a drive signal for dispensing ink droplets for dot formation to the printing head 230. When the dot data is data of three or more values, the controller 210 outputs a drive signal for dispensing an ink droplet for a large dot when the dot data is "large dot formation", and outputs a drive signal for dispensing an ink droplet for a small dot when the dot data is "small dot formation".

The printing medium ME0 is not particularly limited, and includes paper, fabric, resin, metal, and the like. The shape of the printing medium ME0 may be a cut two-dimensional shape or a roll shape.

As shown in FIG. 2, the chart CH0 on the printing medium ME0 includes a plurality of pattern arrays P0 including a plurality of patches PA0 having different dispensing amounts of the ink 236. The plurality of pattern arrays P0 shown in FIG. 2 include pattern arrays P11, P12, P13, and P14 of a primary color, pattern arrays P21, P22, and so on of a secondary color, and a pattern array P31 of a tertiary color. The primary color is a color expressed by only one type of ink, the secondary color is a color expressed by two types of inks having different colors, and the tertiary color is a color expressed by three types of inks having different colors. In each of the pattern arrays P0, the patches PA0 are arranged in an ink amount order QO1 that means an order of the ink amount Q1 per unit area. The patch PA0 collectively refers to a trained patch PA1 included in the trained chart CH1 and the test patch PA2 included in the test chart CH2.

As a schematically simplified example, 5 × 5 = 25 pixels PX0 are shown as a predetermined number of pixels PX0 corresponding to a unit area in a region surrounded by a two-dot chain line in FIG. 2. Obviously, the predetermined number corresponding to the unit area is not limited to 25, and a larger area may be treated as the unit area. The ink amount Q1 per unit area means a ratio (including percentage) of the number of ink droplets 237 dispensed to the predetermined number of pixels PX0, and means a ratio when converted to the largest ink droplet when the ink droplets 237 having different sizes are dispensed to the pixel PX0. The area surrounded by the two-dot chain line in FIG. 2 indicates that the ink amount Q1 per unit area of the patch PA0 is (20/25) × 100 = 80%. When a mixed color image of a secondary color or the like is formed, since a plurality of types of ink droplets 237 are dispensed to one pixel PX0, Q1 > 100% may be satisfied. For example, the ink amount Q1 per unit area of the secondary color is 200% at maximum.

Each patch PA0 is a quadrangle and includes a plurality of solid regions PA3 and a plurality of line regions PA4. In FIG. 2, four solid regions PA3 are present in each patch PA0, and the line region PA4 is present between the solid regions PA3. The solid region PA3 means a region in which the type of the ink 236 does not change and the ink amount Q1 per unit area is uniform. The line region PA4 in which the ink 236 is dispensed also means a region in which the type of the ink 236 does not change and the ink amount Q1 per unit area is uniform. For example, the primary color pattern array P11 includes a C solid region PA3 and an M line region PA4, and the primary color pattern array P12 includes an M solid region PA3 and a Y line region PA4. The secondary color pattern arrays P21, P22, and so on include a secondary color solid region PA3, and may include a secondary color line region PA4. The line region PA4 may be a region where the ink 236 is not dispensed.

By observing the printing medium ME0 on which the plurality of patches PA0 having different ink amounts Q1 per unit area are formed, it is possible to determine a relationship between the phenomenon such as "interruption" of the line region PA4, "thinning" of the line region PA4, "thickening" of the line region PA4, "adjacent" of the line region PA4, "bleeding" of the ink, "aggregation" of the ink, and "overflow" of the ink, and the ink amount Q1 per unit area. The "interruption" of the line region PA4 means a phenomenon in which a part of the line region PA4 is missing. The "thinning" of the line region PA4 means a phenomenon in which a width of the line region PA4 is smaller than an original width of the line region PA4 although the "thinning" does not lead to "interruption". The "thickening" of the line region PA4 means a phenomenon in which the line region PA4 is thicker than the original width thereof. The "bleeding" of the ink means a phenomenon in which an outline of the patch PA0 is ambiguous due to bleeding of the ink to the surroundings. The "aggregation" of the ink means a phenomenon in which the dispersibility of ink dots decreases due to aggregation of color materials. The "overflow" of the ink means a phenomenon in which the shape of the patch PA0 collapses due to the ink protruding from the region of the original patch PA0. These phenomena are described in JP-A-2021-24152.

When the maximum ink amount Qm (see FIG. 9), which is the upper limit of the ink amount Q1 per unit area in the printing medium ME0, is too large, the color of a dark region in the print image IM0 is saturated, and thus the image quality decreases. On the other hand, when the maximum ink amount Qm is too small, the color development of the print image IM0 decreases. As a result of the repeated test, it is found that the above-described phenomena occur locally in the patch PA0 instead of the entire patch PA0, and the local phenomena affect the image quality of the print image IM0.

Therefore, as shown in FIGS. 3 to 5, the trained model generation device 2 in the present specific example generates the trained model 300 for acquiring a predicted value PV1 indicating the probability that the ink amount Q1 per unit area of each divided test image 142 is appropriate as the maximum ink amount Qm. Here, when the recommended value obtained from an inference result of the trained model 300 is automatically determined as the maximum ink amount Qm, even when the user cannot satisfy the determined maximum ink amount Qm, the color conversion LUT is generated according to the inference result. Therefore, as shown in FIGS. 6 and 7, the support device 3 in the present specific example provides the user with prediction information 400 indicating whether the ink amount Q1 per unit area of each test image 141 is in the appropriate range of the maximum ink amount Qm or out of the appropriate range. The trained model generation device 2 and the support device 3 are positioned to support the determination of the maximum ink amount Qm by the user.

FIG. 3 schematically shows the training chart image 120 and the test chart image 140. FIG. 3 collectively shows the training chart image 120 and the test chart image 140.

The training chart image 120 is obtained by reading the trained chart CH1 shown in FIG. 2 by the reading device 260 (see FIG. 1). When reading the trained chart CH1 on the print image IM0, the reading device 260 generates a plurality of training images 121 respectively corresponding to the plurality of trained patches PA1 included in the trained chart CH1. Therefore, the plurality of training images 121 are obtained by reading the plurality of trained patches PA1 having different ink amounts Q1 per unit area. The plurality of training images 121 are transmitted to the information processing device 100 indirectly or directly. Upon receiving the plurality of training images 121, the information processing device 100 holds the plurality of training images 121 in the RAM 113. The information processing device 100 may store the plurality of training images 121 in the storage device 114. In order to generate the trained model 300 shown in FIG. 5, each of the training images 121 is divided vertically and horizontally into N divided training images 122.

The test chart image 140 is obtained by reading the test chart CH2 shown in FIG. 2 by the reading device 260. When reading the test chart CH2 on the print image IM0, the reading device 260 generates a plurality of test images 141 respectively corresponding to the plurality of test patches PA2 included in the test chart CH2. Therefore, the plurality of test images 141 are obtained by reading the plurality of test patches PA2 having different ink amounts Q1 per unit area. The plurality of test images 141 are transmitted to the information processing device 100 indirectly or directly. Upon receiving the plurality of test images 141, the information processing device 100 holds the plurality of test images 141 in the RAM 113. The information processing device 100 may store a plurality of test images 141 in the storage device 114. Since the trained model 300 shown in FIG. 5 is used, each of the test images 141 is divided vertically and horizontally into N divided test images 142. That is, the number of divisions of the test image 141 is the same as the number of divisions N of the training image 121.

The number of divisions N is not particularly limited, and may be a number capable of detecting the above-described phenomenon, such as 50 to 5000.

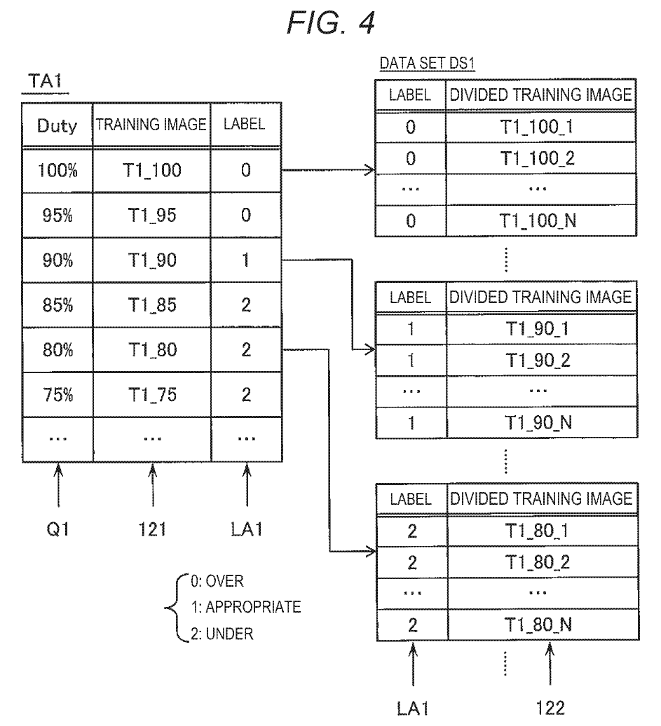

FIG. 4 schematically shows an example of generating a data set DS1 from the plurality of training images 121 having different ink amounts Q1 per unit area. "Duty" of a label table TA1 shown in FIG. 4 means the ink amount Q1 per unit area.

First, as shown in the label table TA1, an operation of associating the training image 121 with a label LA1 is performed for each ink amount Q1 per unit area. In each label LA1 shown in FIG. 4, the ink amount Q1 per unit area of the corresponding trained patch PA1 is "1" when the ink amount Q1 is appropriate as the maximum ink amount Qm, "0" when the ink amount Q1 exceeds the appropriate ink amount Qm, and "2" when the ink amount Q1 falls below the appropriate ink amount Qm. The label LA1 indicates whether the ink amount Q1 per unit area of each of the trained patches PA1 is appropriate as the maximum ink amount Qm, exceeds the appropriate amount, or falls below the appropriate amount. Obviously, the numerical value of the label LA1 can be changed as appropriate. In this specific example, the label table TA1 is generated for each pattern array P0 shown in FIGS. 2 and 3. The label LA1 is given by an observer who views the trained chart CH1. That is, for each pattern array P0, the observer assigns a label "1" to the ink amount Q1 per unit area of the trained patch PA1 determined to be appropriate as the maximum ink amount Qm, assigns a label "0" to the ink amount Q1 per unit area of the trained patch PA1 determined to be more than appropriate as the maximum ink amount Qm, and assigns the label "2" to the ink amount Q1 per unit area of the trained patch PA1 determined to be less than appropriate as the maximum ink amount Qm. In this specific example, the ink amount Q1 per unit area to which the label "1" that means "appropriate" is applied for each pattern array P0 is one.

Next, each of the training images 121 is divided into N divided training images 122, and processing of associating the label LA1 corresponding to the original training image 121 with all the divided training images 122 is performed. For example, the trained model generation device 2 divides the training image "T1_100" of Q1 = 100% into N divided training images of "T1_100_1" to "T1_100_N", and associates the label "0" of Q1 = 100% with all the divided training images of "T1_100_1" to "T1_100_N". The trained model generation device 2 divides the training image "T1_90" of Q1 = 90% into N divided training images of "T1_90_1" to "T1_90_N", and associates the label "1" of Q1 = 90% with all the divided training images of "T1_90_1" to "T1_90_N". The trained model generation device 2 divides the training image "T1_80" of Q1 = 80% into N divided training images "T1_80_1" to "T1_80_N", and associates the label "2" of Q1 = 80% with all the divided training images "T1_80_1" to "T1_80_N". A collection of these pieces of data is the data set DS1 input to a neural network serving as the trained model 300.

FIG. 5 schematically shows the trained model 300 generated by the trained model generation device 2 and used by the support device 3. The trained model generation device 2 in the present specific example generates the trained model 300 for each type of the printing medium ME0, and further generates the trained model 300 for each pattern array P0. When an output resolution of the printer 200 can be changed, the trained model generation device 2 may further generate the trained model 300 for each output resolution.

The trained model generation device 2 generates the trained model 300 by inputting the data set DS1 in which the label LA1 is associated with all the divided training images 122 to the neural network. The trained model generation device 2 repeatedly performs machine learning of the provisional trained model 300 so that the probability that the output is the label LA1 with respect to the input of the divided training image 122 increases. For example, the trained model 300 calculates a feature vector for distinguishing the label LA1 from each divided training image 122 for each input to the provisional trained model 300, and repeatedly performs the above-described machine learning based on the feature vector. The neural network performs the machine learning based on the relationship between the label LA1 and the plurality of divided training images 122. By inputting the divided test image 142, the obtained trained model 300 can output a predicted value PV0 indicating a probability that the divided test image 142 corresponds to the label "0", a predicted value PV1 indicating a probability that the divided test image 142 corresponds to the label "1", and a predicted value PV2 indicating a probability that the divided test image 142 corresponds to the label "2". The trained model 300 causes the information processing device 100 to function to acquire the predicted value PV1 indicating the probability that the ink amount Q1 per unit area of the divided test image 142 is appropriate as the maximum ink amount Qm based on the divided test image 142.

In order to input the plurality of divided test images 142 to the trained model 300, first, as shown in the test image table TA2, an operation of associating the test image 141 with each ink amount Q1 per unit area is performed. Next, processing of dividing each of the test images 141 into the N divided test images 142 is performed. For example, the support device 3 divides the test image of "T2_100" of Q = 100% into N divided test images of "T2_100_1" to "T2_100_N". The support device 3 divides a test image "T2_90" of Q = 90% into N divided test images of "T2_90_1" to "T2_90_N", and divides a test image of "T2_80" of Q = 80% into N divided test images of "T2_80_1" to "T2_80_N". These divided test images 142 are input to the trained model 300, and the predicted value PV1 output from the trained model 300 is obtained for each of the divided test images 142.

However, since there are N predicted values PV1 for each ink amount Q1 per unit area, the support device 3 calculates the appropriateness index P by performing statistical processing on the N predicted values PV1 for each ink amount Q1 per unit area. When averaging processing is performed as the statistical processing, the support device 3 calculates an arithmetic mean of the N predicted values PV1 as the appropriateness index P. Obviously, instead of the arithmetic mean, a geometric mean or the like may be calculated. In addition, the support device 3 may arrange the N predicted values PV1 in order (ascending order or descending order) and calculate a median value of the N predicted values PV1 as the appropriateness index P according to the order. In either case, the appropriateness index P indicates the probability that the ink amount Q1 per unit area corresponding to the test image 141 is appropriate.

FIG. 6 schematically shows an example of the prediction information 400 indicating whether the ink amount Q1 per unit area of each test image 141 is in the appropriate range of the maximum ink amount Qm or out of the appropriate range.

As shown in FIG. 6, the calculated appropriateness index P is associated with each ink amount Q1 per unit area, and whether the ink amount Q1 per unit area is in the "appropriate range", "over" exceeding the appropriate range, or "under" falling below the appropriate range is output to the outside with reference to the threshold TH1. The threshold TH1 is applied to the appropriateness index P for each ink amount Q1 per unit area. In the example shown in FIG. 6, when the threshold TH1 is 10% and the ink amount Q1 per unit area is 75% to 90%, the appropriateness indices P(75), P(80), P(85), and P(90) are greater than the threshold TH1, and thus the external output is in the "appropriate range". When the ink amount Q1 per unit area is 95% to 100%, the appropriate indices P(95) and P(100) are equal to or less than the threshold TH1, and Q1 = 95% to 100% exceed the ink amount 75% to 90% per unit area in the appropriate range, and thus the external output is "over". When the ink amount Q1 per unit area is equal to or less than 70%, the appropriateness index P(70) is equal to or less than the threshold TH1, and Q1 ≤ 70% is less than the ink amount 75% to 90% per unit area of the appropriate range, and thus the external output is "under". The prediction information 400 shown in FIG. 6 indicates whether the ink amount Q1 per unit area of the test image 141 is in the appropriate range of the maximum ink amount Qm, exceeds the appropriate range, or falls below the appropriate range.

Further, the ink amount Q1 per unit area in the appropriate range includes the recommended value 410 of the maximum ink amount Qm. The support device 3 determines the recommended value 410 of the maximum ink amount Qm based on the ink amount Q1 per unit area corresponding to each test image 141 and the appropriateness index P. The recommended value 410 may be the ink amount Q1 per unit area having the largest appropriateness index P. Alternatively, the recommended value 410 may be the ink amount per unit area at the center included in the top three ink amounts Q1 per unit area when the ink amounts Q1 per unit area are arranged in the order of the appropriateness index P (ascending order or descending order). In the example shown in FIG. 6, the top three ink amounts Q1 per unit area are 80%, 85%, and 90% in the appropriate range, and Q1 = 85% at the center thereof is the recommended value 410.

FIG. 7 schematically shows a display example of an assist screen 500 including the prediction information 400 based on the appropriateness index P for each ink amount Q1 per unit area.

The processing unit 110 shown in FIG. 1 can cause the display device 116 to display a plurality of display patches 510 respectively corresponding to the plurality of test patches PA2 shown in FIG. 2. The plurality of display patches 510 include, for each pattern array P0, a plurality of appropriate range patches 511 in which the corresponding ink amount Q1 per unit area is in the appropriate range, and a plurality of inappropriate range patches 512 that are not the appropriate range patches 511. The plurality of inappropriate range patches 512 include a plurality of display patches exceeding the appropriate range and a plurality of display patches falling below the appropriate range. Therefore, the inappropriate range patch above the appropriate range patch 511 among the plurality of inappropriate range patches 512 for each pattern array P0 indicates that the ink amount Q1 per unit area of the test image 141 exceeds the appropriate range of the maximum ink amount Qm. The inappropriate range patch below the appropriate range patch 511 among the plurality of inappropriate range patches 512 for each pattern array P0 indicates that the ink amount Q1 per unit area of the test image 141 falls below the appropriate range of the maximum ink amount Qm. The processing unit 110 causes the display device 116 to display the plurality of display patches 510 including the display information 515 that makes the plurality of appropriate range patches 511 to stand out by thinning the plurality of inappropriate range patches 512 as the prediction information 400. The display of the plurality of inappropriate range patches 512 may be grayed out to prohibit reception of an operation on each of the plurality of inappropriate range patches 512. The display information 515 can be information that distinguishes the plurality of appropriate range patches 511 from the plurality of inappropriate range patches 512 as the prediction information 400.

In addition to the prediction information 400, the processing unit 110 causes the display device 116 to display the recommended patch 520 indicating the recommended value 410 shown in FIG. 6. The assist screen 500 shown in FIG. 7 includes the recommended patch 520 for each of the pattern arrays P0. Each of the recommended patches 520 shown in FIG. 7 is surrounded by a thick line so as to stand out. The recommended patch 520 is an example of recommendation information output to the outside.

The input device 115 can receive an operation of selecting any of the plurality of appropriate range patches 511 for each of the pattern arrays P0. Alternatively, the input device 115 may receive an operation of selecting any of the plurality of display patches 510 for each of the pattern arrays P0. The input device 115 can be an operation unit for receiving an operation on the plurality of display patches 510 displayed on the display device 116.

### 3. Specific Example of Trained Model Generation Processing:

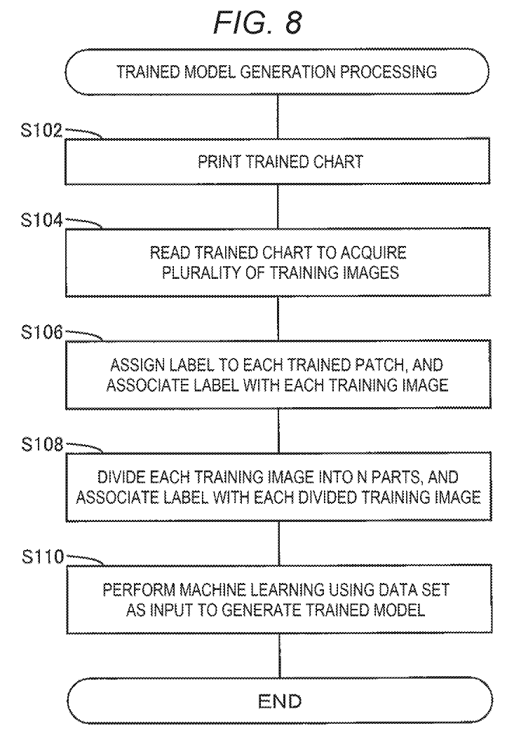

FIG. 8 schematically shows trained model generation processing performed by the trained model generation device 2. Hereinafter, the trained model generation processing of steps S102 to S110 will be described with reference to FIGS. 1 to 5. The description of the "step" is omitted, and the reference numeral of the step may be shown in parentheses.

The subject of the trained model generation processing is the processing unit 110. The trained model generation processing starts when the input device 115 receives an operation for generating the trained model 300.

When the trained model generation processing is started, the processing unit 110 performs control of forming the trained chart CH1 as shown in FIG. 2 on the printing medium ME0 in (S102). As described above, the trained chart CH1 includes a plurality of trained patches PA1 having different ink amounts Q1 per unit area. For example, the storage device 114 stores trained chart print data for causing the printer 200 to print the trained chart CH1, and the processing unit 110 transmits the trained chart print data to the printer 200, so that the trained chart CH1 is formed on the printing medium ME0. When the trained chart CH1 is prepared, the processing of S102 may be omitted.

Next, the processing unit 110 causes the reading device 260 to read the trained chart CH1 on the printing medium ME0, acquires the generated training chart image 120 (see FIG. 3), and stores the training chart image 120 in the RAM 113 (S104). The training chart image 120 includes the plurality of training images 121 respectively corresponding to a plurality of trained patches PA1 having different ink amounts Q1 per unit area.

Next, the processing unit 110 performs processing of assigning the label LA1 to each trained patch PA1, and associates the label LA1 with each training image 121 as in the label table TA1 shown in FIG. 4 (S106). As described above, the label LA1 indicates whether the ink amount Q1 per unit area of each of the trained patches PA1 is appropriate as the maximum ink amount Qm, exceeds the appropriate amount, or falls below the appropriate amount. The processing of assigning the label LA1 may be processing of receiving an input of a numerical value of the label LA1 for each of the trained patches PA1 via the input device 115. In this case, the observer of the trained chart CH1 may input "1" when the ink amount Q1 per unit area of the trained patch PA1 is appropriate as the maximum ink amount Qm, input "0" when the ink amount Q1 per unit area of the trained patch PA1 exceeds the appropriate ink amount Qm, and input "2" when the ink amount Q1 per unit area of the trained patch PA1 falls below the appropriate ink amount Qm. When the numerical value of the label LA1 is input, the processing unit 110 generates the label table TA1 by associating the training image 121 with the numerical value of the label LA1 for each ink amount Q1 per unit area for each pattern array P0.

Next, the processing unit 110 generates the data set DS1 as shown in FIG. 4 (S108). At this time, the processing unit 110 divides each of the training images 121 into the N divided training images 122, and associates the label LA1 corresponding to the original training image 121 with all the divided training images 122. Accordingly, the data set DS1 in which the label LA1 is associated with each of the divided training images 122 is generated for each of the pattern arrays P0.

Finally, the processing unit 110 performs the machine learning using the data set DS1 as an input, and generates the trained model 300 (S110). As shown in FIG. 5, the trained model 300 causes the information processing device 100 to function to acquire the predicted values PV0, PV1, and PV2 indicating the probability that the divided test image 142 corresponds to the label LA1 by inputting the divided test image 142. The processing unit 110 generates the trained model 300 described above by the machine learning based on the relationship between the label LA1 and the plurality of divided training images 122.

### 4. Specific Example of Support Processing:

FIG. 9 schematically shows support processing performed by the support device 3. Here, S206 corresponds to the division processing (a1) and the division step ST1. S208 corresponds to the predicted value acquisition processing (a2) and the predicted value acquisition step ST2. S210 to S214 correspond to the output processing (a3) and the output step ST3. S216 corresponds to the maximum ink amount setting processing (a4 or a5) and a maximum ink amount determination step ST4. FIG. 10 schematically shows the classification processing performed in S212 of FIG. 9. Hereinafter, the support processing of S202 to S216 will be described with reference to FIGS. 1 to 7.

The subject of the support processing is the processing unit 110. The support processing starts when the input device 115 receives an operation for determining the maximum ink amount Qm.

When the support processing is started, the processing unit 110 performs control of forming the test chart CH2 as shown in FIG. 2 on the printing medium ME0 (S202). As described above, the test chart CH2 includes a plurality of test patches PA2 having different ink amounts Q1 per unit area. For example, the storage device 114 stores test chart print data for causing the printer 200 to print the test chart CH2, and the processing unit 110 transmits the test chart print data to the printer 200, so that the test chart CH2 is formed on the printing medium ME0. When the test chart CH2 is prepared, the processing of S202 may be omitted.

Next, the processing unit 110 causes the reading device 260 to read the test chart CH2 on the printing medium ME0, acquires the generated test chart image 140 (see FIG. 3), and stores the test chart image 140 in the RAM 113 (S204). The test chart image 140 includes a plurality of test images 141 respectively corresponding to a plurality of test patches PA2 having different ink amounts Q1 per unit area.

Next, the processing unit 110 acquires the N divided test images 142 by dividing each of the test images 141 into N pieces (S206).

Next, the processing unit 110 acquires the predicted value PV1 (see FIG. 5) of the label "1" that means the appropriate range by executing the trained model 300 using each of the divided test images 142 as an input (S208). In S208, N predicted values PV1 are acquired for each of the divided test images 142. In S208, the processing unit 110 may acquire the predicted value PV0 of the label "0" that means exceeding the appropriate range, or may acquire the predicted value PV2 of the label "2" that means falling below the appropriate range.

Next, the processing unit 110 performs statistical processing on the N predicted values PV1 obtained by executing the trained model 300 for each of the test images 141 to calculate the appropriateness index P as shown in FIG. 6 (S210). For example, the processing unit 110 calculates the arithmetic mean of the N predicted values PV1 as the appropriateness index P for each of the test images 141. As described above, the appropriateness index P indicates the probability that the ink amount Q1 per unit area corresponding to the test image 141 is appropriate.

N predicted values PV0 may be added to the calculation of the appropriateness index P, and N predicted values PV2 may be added to the calculation of the appropriateness index P.

Next, the processing unit 110 performs classification processing of the ink amount Q1 per unit area in (S212). Hereinafter, an example of the classification processing will be described with reference to FIG. 10.

When the classification processing is started, the processing unit 110 causes the display device 116 to display an appropriate range selection screen 530 as shown in FIG. 10 (S302). The appropriate range selection screen 530 includes a plurality of options 531 for substantially selecting the threshold TH1 to be applied to the appropriateness index P for each of the ink amounts Q1 per unit area, and an OK button 532. The plurality of options 531 include "narrow" for determining the appropriate range of the maximum ink amount Qm under strict conditions, "normal" for determining the appropriate range under recommended conditions, and "wide" for determining the appropriate range under gentle conditions. When "narrow" is selected, the threshold TH1 is set greater than when "normal" is selected, and when "wide" is selected, the threshold TH1 is set smaller than when "normal" is selected. The input device 115 can receive an operation of selecting any one of the plurality of options 531. After the operation of the option 531 is received, when the input device 115 receives the operation of the OK button 532, the processing unit 110 sets the threshold TH1 according to the selected option 531. Therefore, the input device 115 can be an operation unit for receiving an operation of changing the threshold TH1.

Next, the processing unit 110 classifies the ink amount Q1 per unit area in which the appropriateness index P exceeds the threshold TH1 into the "appropriate range" (S304). In the example shown in FIG. 6, since the appropriateness indices P(75), P(80), P(85), and P(90) are greater than the threshold TH1, Q1 = 75% to 90% is classified as the "appropriate range". The processing unit 110 determines that the ink amount Q1 per unit area in which the calculated appropriateness index P exceeds the threshold TH1 is within the appropriate range.

Next, the processing unit 110 determines the recommended value 410 (see FIG. 6) of the maximum ink amount Qm from the ink amount Q1 per unit area in the appropriate range (S306). For example, the processing unit 110 determines the ink amount per unit area having the largest appropriateness index P among the ink amounts Q1 per unit area in the appropriate range as the recommended value 410. Alternatively, the processing unit 110 may determine, as the recommended value 410, the ink amount per unit area at the center included in the upper three ink amounts per unit area of the appropriateness index P among the ink amounts Q1 per unit area of the appropriate range.

As described above, the processing unit 110 determines the recommended value 410 based on the ink amount Q1 per unit area corresponding to each of the test images 141 and the plurality of predicted values PV1.

Next, the processing unit 110 classifies the ink amount Q1 per unit area in which the appropriateness index P does not exceed the threshold TH1 into "over" or "under" (S308). In the example shown in FIG. 6, since the appropriateness indices P(95) and P(100) satisfying Q1 > 90% are equal to or less than the threshold TH1, Q1 = 95% to 100% is classified as "over". Since the appropriateness index P(70) of Q1 < 75% is equal to or less than the threshold TH1, Q1 ≤ 70% is classified as "under". The processing unit 110 determines that the ink amount Q1 per unit area in which the calculated appropriateness index P does not exceed the threshold TH1 is out of the appropriate range.

As described above, the ink amount Q1 per unit area is classified into three classes of "appropriate range", "over", and "under" for each type of the printing medium ME0 and for each pattern array P0. The classification may be performed for each output resolution. When the display patch 510 is displayed in the same mode of "over" and "under", the processing unit 110 may collectively classify "over" and "under" into "out of appropriate range".

Finally, the processing unit 110 generates the prediction information 400 for display (see FIG. 7) based on the classification of the ink amount Q1 per unit area (S310). The prediction information 400 shown in FIG. 7 includes the display information 515 for distinguishing the plurality of appropriate range patches 511 from the plurality of inappropriate range patches 512, and information for displaying the recommended patch 520 indicating the recommended value 410 is added.

As described above, the processing unit 110 generates the prediction information 400 based on the appropriateness index P for the ink amount Q1 per unit area.

After the classification processing ends, the processing unit 110 causes the display device 116 to display the assist screen 500 including the plurality of display patches 510 in which the ink amount Q1 per unit area is classified (S214 shown in FIG. 9). The assist screen 500 shown in FIG. 7 includes the prediction information 400 indicating whether the ink amount Q1 per unit area of each of the test images 141 is in the appropriate range of the maximum ink amount Qm or out of the appropriate range. The assist screen 500 includes the recommended patch 520 indicating the recommended value 410 in addition to the prediction information 400.

As described above, the processing unit 110 performs processing of outputting the prediction information 400 based on the ink amount Q1 per unit area corresponding to each of the test images 141 and the plurality of predicted values PV1, and further outputting the recommended patch 520 in addition to the prediction information 400.

Finally, the processing unit 110 receives an operation on any of the plurality of appropriate range patches 511 via the input device 115, and sets the ink amount Q1 per unit area corresponding to the operated appropriate range patch 511 to the maximum ink amount Qm (S216). For example, when the appropriate range patch 511 of Q1 = 80% in the pattern array P0 of "C/M" is operated on the assist screen 500 shown in FIG. 7, the processing unit 110 sets the maximum ink amount Qm of C to 80%. In this case, the maximum ink amount Qm different from the recommended value 85% indicated by the recommended patch 520 is set. Obviously, when the recommended patch 520 in the pattern array P0 of "C/M" is operated, the processing unit 110 sets the maximum ink amount Qm of C to the recommended value 85%.

The maximum ink amount Qm is not limited to being set for each of the pattern arrays P0, and the primary colors may be collectively set, or the secondary colors may be collectively set. In this case, when the appropriate range patch 511 of Q1 = 80% in any of the pattern arrays P0 of the primary color is operated, the processing unit 110 sets the maximum ink amount Qm of the primary color to 80%. When the maximum ink amount Qm in which the primary colors are collected is set, the trained model 300 for the primary colors may be generated by machine learning based on the data set DS1 in which the primary colors are collected. When the maximum ink amount Qm in which the secondary colors are collected is set, the trained model 300 for the secondary colors may be generated by machine learning based on the data set DS1 in which the secondary colors are collected.

When the processing unit 110 prohibits the input device 115 from receiving an operation on each of the inappropriate range patches 512, even when the inappropriate range patch 512 is operated, the corresponding ink amount Q1 per unit area is not set to the maximum ink amount Qm. On the other hand, the processing unit 110 may permit the input device 115 to receive an operation on each of the inappropriate range patches 512 in addition to each of the appropriate range patches 511. For example, when the inappropriate range patch 512 of Q1 = 95% in the pattern array P0 of "C/M" is operated on the assist screen 500 shown in FIG. 7, the processing unit 110 sets the maximum ink amount Qm of C or the primary color to 95%.

The determined maximum ink amount Qm is used for creating the color conversion LUT 600 (see FIG. 11) to be referred to in the color conversion processing. As shown in FIG. 11, it is assumed that the coordinate values (C, M, Y, K) = (Ci, Mi, Yi, Ki) of the ink amount data are associated with the grid point GD1 in which the coordinate values (R, G, B) of the RGB data are (Ri, Gi, Bi). In this case, the processing unit 110 generates the color conversion LUT 600 such that an ink amount obtained by combining an ink amount corresponding to a coordinate value Ci, an ink amount corresponding to a coordinate value Mi, an ink amount corresponding to a coordinate value Yi, and an ink amount corresponding to a coordinate value Ki is equal to or less than the maximum ink amount Qm. When the color conversion processing is performed according to the color conversion LUT 600 generated in this manner, the ink amount per unit area in the print image IM0 is limited to the maximum ink amount Qm or less.

Obviously, the color conversion LUT is not limited to the color conversion LUT 600 described above. Input coordinate values of the color conversion LUT may be coordinate values of C, M, and Y, coordinate values of C, M, Y, and K, or the like. Output coordinate values of the color conversion LUT may be coordinate values of C, M, Y, K, and special colors. Examples of the special color include Or (orange), Gr (green), Lc (light cyan) lower in density than C, Lm (light magenta) lower in density than M, Dy (dark yellow) higher in density than Y, and Lk (light black) lower in density than K. Further, the processing unit 110 may generate the print data after converting the RGB data or the like into the ink amount data according to the color conversion LUT having a possibility of exceeding the maximum ink amount Qm and converting the ink amount of each pixel of the ink amount data into the maximum ink amount Qm or less.

As shown in FIG. 5, the trained model 300 generated by the trained model generation processing shown in FIG. 8 causes the information processing device 100 to function to acquire, based on the plurality of divided test images 142 obtained by dividing each of the plurality of test images 141 obtained by reading the plurality of test patches PA2 having different ink amounts Q1 per unit area on the printing medium ME0 into N pieces, the predicted value PV1 indicating the probability that the ink amount Q1 per unit area of each of the divided test images 142 is appropriate as the maximum ink amount Qm. When the trained model 300 is executed by inputting the N divided test images 142 obtained by dividing each of the plurality of test images 141 obtained by reading the plurality of test patches PA2 having different ink amounts Q1 per unit area, N predicted values PV1 indicating a probability that the ink amount Q1 per unit area of each divided test image 142 is appropriate as the maximum ink amount Qm are acquired. Accordingly, information indicating that the ink amount Q1 per unit area is predicted to be appropriate or inappropriate as the maximum ink amount Qm is finely obtained for each of the test patches PA2.

The prediction information 400 output by the support processing shown in FIG. 9 is based on the ink amount Q1 per unit area and the N predicted values PV1 corresponding to each of the test images 141. The prediction information 400 is not limited to one recommended value, and indicates whether the ink amount Q1 per unit area of each of the test images 141 is in the appropriate range of the maximum ink amount Qm or out of the appropriate range. Accordingly, a user can reflect his/her desire in the determination of the maximum ink amount Qm while referring to the appropriate range predicted with a width. Therefore, in the specific example, the user can determine the maximum ink amount in consideration of his/her desire.

### 5. Modifications:

Various modifications of the present disclosure are conceivable.

For example, elements other than the label LA1 and the divided training image 122 may be added to the data set DS1 for machine learning. When the trained model generation device 2 generates the trained model 300 in which the primary colors or the secondary colors are collected, color information of the solid region PA3 and color information of the line region PA4 may be added to the data set DS1. In this case, the support device 3 can acquire the predicted value PV1 by executing the trained model 300 using the divided test image 142, the color information of the solid region PA3, and the color information of the line region PA4 as inputs, and can output the prediction information 400. When the trained model generation device 2 generates the trained model 300 in which a plurality of types of printing media ME0 are collected, type information of the printing medium ME0 may be added to the data set DS1. In this case, the support device 3 can acquire the predicted value PV1 by executing the trained model 300 using the divided test image 142 and the type information of the printing medium ME0 as inputs, and can output the prediction information 400. Further, an element such as an output resolution may be added to the data set DS1.

The patch PA0 including the trained patch PA1 and the test patch PA2 may be a solid patch in which the line region PA4 does not exist, the type of the ink 236 does not change, and the ink amount Q1 per unit area is uniform. Even in this case, since phenomena such as "bleeding" of ink, "aggregation" of ink, and "overflow" of ink may occur, the predicted value PV1 can be acquired using the trained model 300, and the prediction information 400 can be output.

By the support processing shown in FIG. 9, the ink amount of the test patch PA2 selected by the user is appropriate as the maximum ink amount Qm for the user. Therefore, the trained model generation device 2 may perform additional machine learning using the test chart CH2 used for determining the maximum ink amount Qm as the additional trained chart CH1. The trained model 300 is updated by additional machine learning based on a relationship between a label indicating whether the ink amount Q1 per unit area of each additional trained patch PA1 is appropriate as the maximum ink amount Qm with the maximum ink amount Qm being appropriate, exceeds the appropriate ink amount Qm, or falls below the appropriate ink amount Qm, and the divided test image 142 as the additional divided training image 122.

In the processing described above, for example, the determination of whether the value "exceeds" can be replaced with the determination of whether the value is "equal to or greater than", and the determination of whether the value is "equal to or less than" can be replaced with the determination of whether the value is "smaller than". Replacement of the determination as described above is also included in the aspect of the present application.

### 6. Conclusion:

As described above, according to the present disclosure, it is possible to provide a configuration or the like in which a user can determine a maximum ink amount in consideration of his/her desire according to various aspects. Obviously, the basic functions and effects described above can also be achieved by configurations having only configuration requirements according to the independent claims.

Further, it is possible to implement a configuration in which the elements disclosed in the examples described above are replaced with one another or the combinations thereof are changed, a configuration in which the elements disclosed in known technologies and the examples described above are replaced with one another or the combinations thereof are changed, and the like. The present disclosure also includes these configurations described above and the like.

What is claimed is:

1. A support device for supporting determination of a maximum ink amount, that is an upper limit of an ink amount per unit area on a printing medium, the support device comprising:
a holding unit configured to hold a plurality of test images respectively obtained by reading a plurality of test patches having different ink amounts per unit area on the printing medium; and
a processing unit configured to execute a trained model that causes a computer to function to acquire, based on a plurality of divided test images obtained by dividing each of the test images into a predetermined number, a predicted value indicating a probability that the ink amount per unit area of each of the divided test images is appropriate as the maximum ink amount, wherein
the processing unit performs
division processing of dividing each of the test images into the predetermined number to acquire the plurality of divided test images,
predicted value acquisition processing of executing the trained model using each of the divided test images as an input to acquire the predicted value, and
output processing of outputting, based on the ink amount per unit area corresponding to each of the test images and the plurality of predicted values, prediction information indicating whether the ink amount per unit area of each of the test images is within an appropriate range of the maximum ink amount or out of the appropriate range.

2. The support device according to claim 1, wherein
in the output processing, the processing unit
performs statistical processing on the plurality of predicted values obtained by executing the trained model for each of the test images to calculate an appropriateness index indicating the probability that the ink amount per unit area corresponding to the test image is appropriate,
generates the prediction information based on the appropriateness index for each of the ink amounts per unit area, and
outputs the prediction information.

3. The support device according to claim 2, wherein
in the output processing, the processing unit compares the calculated appropriateness index with a threshold and determines that the ink amount per unit area in which the appropriateness index exceeds the threshold is within the appropriate range, and
the support device further includes an operation unit configured to receive an operation of changing the threshold.

4. The support device according to claim 1, wherein
the processing unit is configured to cause a display unit to display a plurality of display patches respectively corresponding to the plurality of test patches,
the plurality of display patches include a plurality of appropriate range patches in which the ink amount per unit area is in the appropriate range and a plurality of inappropriate range patches that are not the appropriate range patches, and
in the output processing, the processing unit causes the display unit to display, as the prediction information, the plurality of display patches including display information for distinguishing the plurality of appropriate range patches from the plurality of inappropriate range patches.

5. The support device according to claim 4, further comprising:
an operation unit configured to receive an operation on the plurality of display patches displayed on the display unit, wherein
when the operation unit receives an operation on any of the plurality of display patches, the processing unit further performs maximum ink amount setting processing of setting the ink amount per unit area corresponding to the operated display patch to the maximum ink amount.

6. The support device according to claim 4, further comprising:
an operation unit configured to receive an operation on the plurality of display patches displayed on the display unit, wherein
when the processing unit prohibits the operation unit from receiving an operation on the plurality of inappropriate range patches, and when the operation unit receives an operation on any of the plurality of appropriate range patches, the processing unit further performs maximum ink amount setting processing of setting the ink amount per unit area corresponding to the operated appropriate range patch to the maximum ink amount.

7. The support device according to claim 1, wherein
in the output processing, the processing unit
determines a recommended value of the maximum ink amount based on the ink amount per unit area corresponding to each of the test images and the plurality of predicted values, and
outputs recommendation information indicating the recommended value in addition to the prediction information.

8. A support method for causing a computer to perform processing of supporting determination of a maximum ink amount that is an upper limit of an ink amount per unit area on a printing medium,
the computer being configured to execute a trained model that causes the computer to function to acquire, based on a plurality of divided test images obtained by dividing each of a plurality of test images obtained by reading a plurality of test patches having different ink amounts per unit area on the printing medium, into a predetermined number, a predicted value indicating a probability that the ink amount per unit area of each of the divided test images is appropriate as the maximum ink amount,
the support method comprising:
a division step of dividing each of the test images into the predetermined number to acquire the plurality of divided test images;
a predicted value acquisition step of executing the trained model using each of the divided test images as an input to acquire the predicted value; and
an output step of outputting, based on the ink amount per unit area corresponding to each of the test images and the plurality of predicted values, prediction information indicating whether the ink amount per unit area of each of the test images is within an appropriate range of the maximum ink amount or out of the appropriate range.

9. A trained model generation device for supporting determination of a maximum ink amount that is an upper limit of an ink amount per unit area on a printing medium, the trained model generation device comprising:
a holding unit configured to hold a plurality of training images respectively obtained by reading a plurality of trained patches having different ink amounts per unit area; and
a processing unit configured to generate a trained model that causes a computer to function to acquire, based on a plurality of divided test images obtained by dividing each of the plurality of test images obtained by reading a plurality of test patches having different ink amounts per unit area in the printing medium into the predetermined number, a predicted value indicating a probability that the ink amount per unit area of each of the divided test images is appropriate as the maximum ink amount, by machine learning based on a relationship between a label indicating whether the ink amount per unit area of each of the trained patches is appropriate as the maximum ink amount, exceeds an appropriate amount, or falls below the appropriate amount, and a plurality of divided training images obtained by dividing each of the training images into the predetermined number.
